(19) United States
(12) Patent Application Publication
(10) Pub. No.: US 2017/0366509 A1
(43) Pub. Date: Dec. 21, 2017

(54) NETWORK CHANNELS PRIMITIVES

(71) Applicant: Lior Malka, San Jose, CA (US)

(72) Inventor: Lior Malka, San Jose, CA (US)

(21) Appl. No.: 15/185,904

(22) Filed: Jun. 17, 2016

(51) Int. Cl. H04L 29/06; H04L 12/911

(52) U.S. Cl. CPC H04L 63/04; H04L 63/10; H04L 47/825; H04L 63/08; H04L 2209/72

(57) ABSTRACT

Networks primitives are provided for establishing and maintaining channels and secure channels. In one embodiment, requests to open a new channel are handled only in a listen mode and, after authentication, the channel provides secure communication. In one embodiment, a secure channel is initialized and fixed if broken so that a plurality of threads may share it. In one embodiment, a no listen mode is applied if the number of new channels handled per time period is more than a threshold.

### BACKGROUND

Computer networks are made from basic building blocks, called network primitives. Computer networks deal with various issues, such as asynchronous execution, multithreading, and faulty channels. However, existing network primitives do not take all of those into account. Consequently, computer networks lack simplicity, reliability, correctness, and efficiency. For example, in existing networks, a server is constantly listening for incoming requests to open a new channel. Depending on the needs of the application, this may be a waste of resources and expose the server to malicious communication.

### SUMMARY

Embodiments are provided for establishing and maintaining channels and secure channels. In one embodiment, switching between a no listen mode and a listen mode determines whether requests to open a new channel are ignored or handled, respectively, and when a channel is established, it is authenticated and may be used for secure communication. Any authentication method may be used. In one embodiment, a secure channel is established and shared by a plurality of threads, and is guaranteed to be renewed if broken. Any method for establishing a secure channel may be used. In one embodiment, a no listen mode and a listen mode are used with a counter and a threshold to limit the number of new channels handled per time period.

### DRAWINGS

The following figures illustrate the embodiments by way of example. They do not limit their scope.

FIG. 1 shows a flow diagram of a method of establishing a secure channel, in accordance with one embodiment.

FIG. 2 shows a flow diagram of a method of establishing and maintaining a secure channel, in accordance with one embodiment.

FIG. 3 shows a flow diagram of a method of limiting new channels handling, in accordance with one embodiment.

### DETAILED DESCRIPTION

This section includes detailed examples, particular embodiments, and specific terminology. These are not meant to limit the scope. They are intended to provide clear and through understanding, cover alternatives, modifications, and equivalents.

Communication involves a plurality of parties. The set of parties that communicate with a party is the neighbors of that party. A party has at least one thread. A thread is a unit of execution, such as a software thread, a hardware thread, a process, and so on. Parties may have a unique identifier and may be in different or identical locations. The location may be represented using a physical or a logical address. For example, two parties on the same device could be threads or processes, identified by a thread id or process id, respectively. The parties communicate via a channel. For example, the channel may be a TCP (Transfer Control Protocol) connection or shared memory or a file. Data sent on the channel may or may not arrive, may or may not be delayed, and may or may not be corrupted. A channel may be closed in any way. For example, a TCP channel may be closed with or without a termination notice.

A party is in listening mode if it accepts requests to open a new channel. Otherwise, it is in a no listen mode. A listening policy selects a listening mode. Any listening policy can be used. For example, in a single channel per neighbor policy, a party listens until a channel has been established with each of its neighbors, and then switches back to a no listen mode, resuming listening only if a channel with one of the neighbors drops. As another example, in an always listen policy, a party is always in a listen mode.

A secure channel provides data confidentiality, data integrity, and authenticity. Elements such as identifiers, tokens, and cryptographic functions may be used to establish a secure channel. For example, encryption provides data confidentiality, signatures provide data integrity, and signcryption provides both. Each pair of parties may or may not have a unique channel, and elements used to establish a channel in one direction may or may not be used to establish a channel in the reverse direction. For example, if each party has unique elements for establishing a secure channel with any other party, then each channel is unique and the elements are unidirectional.

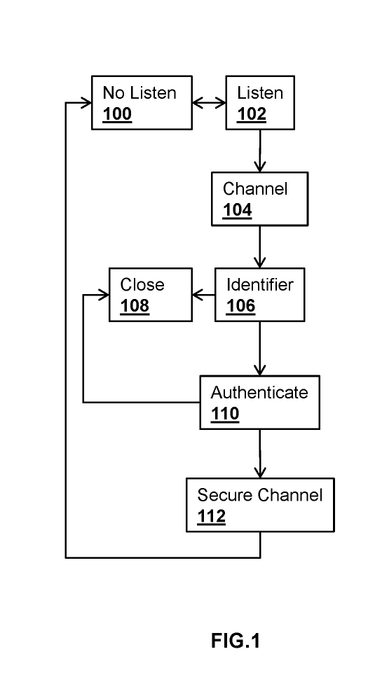

FIG. 1 shows a flow diagram of a method of establishing a secure channel, in accordance with one embodiment. Requests to open a channel are ignored in a no listen 100 mode and accepted in listen 102 mode. Any listening policy, such as a single channel per neighbor policy, may be used. When a request to open a channel is accepted, a channel 104 is established. An identifier 106 is read from the channel. If the identifier is invalid, then the channel is closed 108.

The identifier may be validated in any way. For example, it can be validated using a list, a database, a predicate, and so on. If the identifier is valid, then the channel is authenticated 110. Any authentication method can be used. For example, a signcryption function corresponding to the identifier may be applied to the channel so that a token can be read, and authentication is successful if the token is valid. If authentication is unsuccessful, then the channel is closed. Otherwise, a secure channel 112 is outputted, and one of the listening modes is resumed. The secure channel may be used for secure communication.

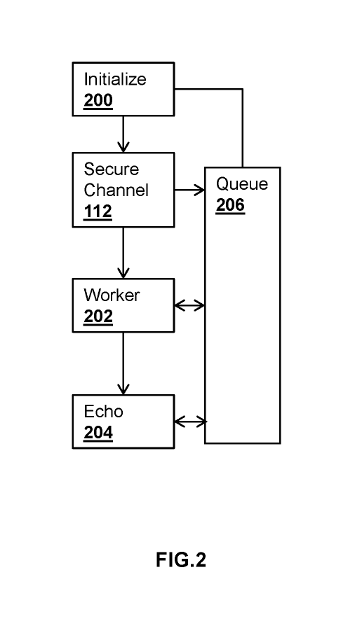

FIG. 2 shows a flow diagram of a method of establishing and maintaining a secure channel, in accordance with one embodiment. An initialization 200 thread establishes a secure channel 112 and waits for a signal. Any method for establishing the secure channel may be used. A worker 202 thread uses the secure channel to execute logic. Any logic may be used. If the secure channel closes for any reason, such as an exception, then the initialization thread is signaled to reestablish the secure channel. Any method for signaling may be used. Any number of worker threads may be used.

The secure channel may be placed in a queue 206 so that it can be shared between more than one thread. The queue is initially empty. At any given time, at most one thread can take the secure channel from the queue or put it back in the queue. Other threads block if the queue is empty. The queue may be used for signaling.

If the secure channel is idle, then a worker thread executing the echo 204 logic sends and receives data on the secure channel. Any data may be sent and received. For example, the echo logic may send a randomly selected first number, read back a second number, and close the secure channel if the first number and the second number are not equal.

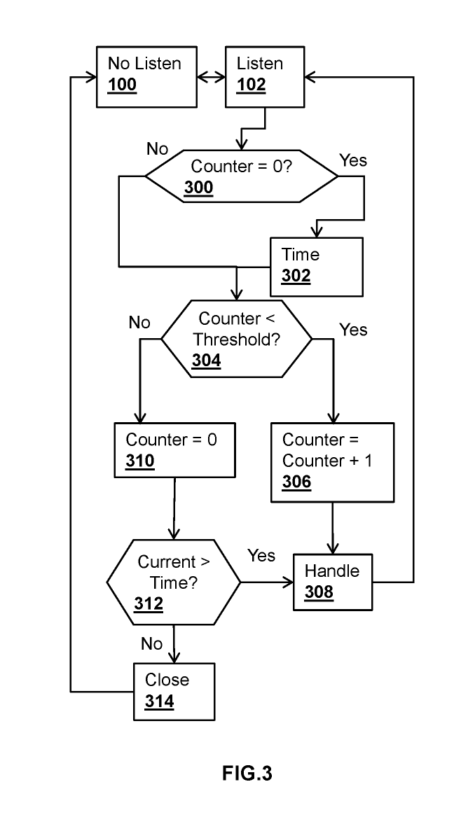

FIG. 3 shows a flow diagram of a method of limiting new channels handling, in accordance with one embodiment. Requests to open a channel are ignored in a no listen 100 mode and accepted in a listen 102 mode. Any listening policy, such as a single channel per neighbor policy, may be used. A counter, a threshold, and a time variable are used. The counter is initially zero. If the counter equals zero 300, then the time variable is set 302 to the current time plus a period. Any value can be used for the threshold and the period. For example, a period of one second and a threshold value of ten mean that at most ten channels would be handled per second. If the counter is smaller than the threshold 304, then the counter is incremented 306, the channel is handled 308, and listening resumes. Otherwise, the counter is reset 310. If the current time is bigger than the time variable 312, then the channel is handled 308 and listening resumes. Otherwise the channel is closed 314, and a no listen mode is selected. Listen mode resumes when the current time equals the time variable.

The handler can execute any logic. For example, the handler may launch a new thread that authenticates the channel so that a secure channel is obtained.

The specific embodiments and specific terminology used above should not be construed as limiting the scope of the embodiments. These details have been presented for purposes of illustration and are not intended to be exhaustive. Many modifications and uses are possible. The scope of the embodiments is defined by the Claims appended hereto and their equivalents.

What is claimed is:

1. A method of establishing a secure channel, the method comprising:
switching between a listen and a no listen mode; and
obtaining a channel when a request to open a channel arrives in listen mode; and
reading an identifier from the channel; and
authenticating the channel if the identifier is valid; and
closing the channel if the identifier is invalid or authentication failed; and
outputting a secure channel if the channel is authentic.

2. The Method of claim 1, wherein the listening policy is a single channel per neighbor.

3. The Method of claim 1, further comprising using the secure channel for secure communication.

4. The Method of claim 1, wherein the identifier is valid if it appears in memory or in a database.

5. The Method of claim 1, wherein authenticating the channel if the identifier is valid is done by obtaining from a database or memory a cryptographic function corresponding to the identifier.

6. The Method of claim 1, further comprising incrementing a counter associated with the identifier if the identifier is valid.

7. A method of establishing and maintaining a secure channel, the method comprising:
initializing an empty blocking queue with a secure channel; and
launching a worker thread that executes an echo logic if the secure channel is idle; and
providing a plurality of worker threads access to the queue; and
signaling an initialization thread to replace the secure channel if the secure channel is broken.

8. The method of claim 7, wherein the plurality of worker threads includes a thread for renewing the secure channel in the queue, and a thread for opening temporary secure channels that are not placed in the queue.

9. The method of claim 7, wherein the blocking queue can also provide the secure channel if the queue has been idle.

10. The method of claim 7, wherein the echo logic sends a randomly selected first number on the secure channel and closes the channel if a second number equal to the first number is not sent in response.

11. A method of limiting new channels handling, the method comprising:
switching between a listen and a no listen mode; and
counting the number of channels established in a time period; and
invoking a hander on the channel if the counter is below a threshold within the period and otherwise closing the channel and not listening until the period is over; and
resuming the listen mode.

12. The Method of claim 11, wherein the listening policy is a single channel per neighbor.

13. The Method of claim 11, wherein the listening policy is always listen.

14. The method of claim 11, wherein the handler launches a new thread that executes logic for establishing a secure channel

15. The method of claim 11 further comprising raising an alert if the counter is not below the threshold within the period.
